(19) United States
(12) Patent Application Publication
(10) Pub. No.: US 2007/0227328 A1
(43) Pub. Date: Oct. 4, 2007

(54) Rotary blade molding method, rotary blade molding die and rotary blade molded by the same

(75) Inventors: Kunihiro Tsuzuki, Obu-city (JP); Shinichi Yokoyama, Gifu-city (JP); Masaki Sakata, Kariya-city (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/727,352

(22) Filed: Mar. 26, 2007

(30) Foreign Application Priority Data
Mar. 29, 2006 (JP) 2006-90802

(51) Int. Cl. B26D 1/00; B29C 45/00; B29C 45/40

(52) U.S. Cl. 83/651; 425/577; 264/328.1

(57) ABSTRACT

A rotary blade molding method, a rotary blade molding die and a rotary blade molded thereby are disclosed. A cavity (79) for molding an impeller (31) is formed between a fixed-side die plate (59) and a movable-side die plate (75). The movable-side die plate (75) has a plurality of outer through holes (81) formed in spaced relation to each other in the peripheral direction on the inner peripheral surface of the cavity (79) and extending in the direction along which the fixed-side die plate (59) and the movable-side die plate (75) move away from or toward each other. Outer ejector pins (83) are removably inserted into the outer through holes (81), respectively. By changing the length of the outer ejector pins (83), the axial position of the forward end surface of each outer ejector pin (83) with respect to the inner peripheral surface of the cavity (79) is changed, so that the thickness of a molded product is changed thereby to adjust the balance of the impeller (31) around the axis thereof. As a result, the unbalance of the rotary blade can be adjusted by an inexpensive and simple method.

### BACKGROUND OF THE INVENTION

1. Field of the Invention

This invention relates to a method and a die for molding a rotary blade used for a blower, a compressor, etc., the rotary blade molded by the method and the die.

2. Description of the Related Art

A vortex electric air pump disclosed in Japanese Unexamined Patent Publication No. 2005-291149 is a known blower having a rotary blade. This air pump is designated by reference numeral 11 in FIG. 3. The vortex electric air pump 11 includes a motor 13, an impeller 17 as a rotary blade mounted on the output shaft 15 of the motor 13, and a blower housing 19 surrounding the impeller 17. The impeller 17 in the blower housing 19 is rotated by the motor 13 and the air taken in from an air duct 21 is moved by the impeller 17 and discharged from a discharge port (not shown).

The noise of this electric air pump is derived from two factors including the radiated sound constituting turbulence noise in the pump flow path and vibration noise due to the vibratory force caused by an unbalance of the rotary members. Of these factors, the vibration noise is caused by an inbalance of a rotary member such as a motor and a impeller. The larger the total amount of the unbalance of the rotary members combined, the larger the vibratory force and hence the larger the vibration noises.

Presently, the balance of the motor is adjusted during the production process thereof. With regard to the impeller, however, a positive balancing process to add a weight in accordance with the amount of the rotation unbalance or a negative balancing process scraping-off the molding resin is executed after molding. The jobs of the positive and negative balancing processes, however, are troublesome and pose the problem of an increased cost.

### SUMMARY OF THE INVENTION

The object of this invention is to solve the above-mentioned problem and provide a method and apparatus for molding a rotary blade with the unbalance thereof adjustable by an inexpensive, simple process and the rotary blade molded by the method and apparatus.

In order to achieve this object, according to one aspect of the invention, there are provided a method or apparatus for molding a rotary blade wherein a cavity (79) for molding a rotary blade (31) having an axis in the direction along which a pair of dies (59, 75) are moved away from and toward each other is formed between the dies (59, 75), wherein a plurality of holes (63, 81, 87) opening to the inner peripheral surface of the cavity (79) in peripherally spaced relation with each other and extending in the direction along which the dies (59, 75) are moved away from or toward each other are formed on at least one of the dies (59, 75), wherein ejector pins (83, 89) are removably inserted in the plurality of the holes (63, 81, 87), respectively, and wherein the thickness of a molded product is changed by changing the length of the ejector pins (83, 89) inserted into the holes and thus changing the axial position of the forward end surfaces of the ejector pins (83, 89) with respect to the inner peripheral surface of the cavity (79) thereby to adjust the balance of the rotary blade (31) around the axis thereof. According to another aspect of the invention, there are provided a method or apparatus for molding a rotary blade, wherein a cavity (79) for molding a rotary blade (31) having an axis in the direction along which a pair of dies (59, 75) are moved away from and toward each other is formed between the dies (59, 75), wherein a plurality of holes (63, 81, 87) opening to the inner peripheral surface of the cavity (79) in a peripherally spaced relation with each other and extending in the direction along which the dies (59, 75) are moved away from or toward each other, are formed on at least one of the dies (59, 75), wherein gate bushings (65) are removably inserted in the plurality of the holes (63, 81, 87), respectively, and wherein the thickness of a molded product is changed by changing the length of the gate bushings (65) inserted into the holes and thus changing the axial position of the forward end surfaces of the gate bushings (65) with respect to the inner peripheral surface of the cavity (79) thereby to adjust the balance of the rotary blade around the axis thereof.

By employing these means, the unbalance of the rotary blade can be adjusted by an inexpensive and simple method using the existing members without adding a columnar core anew.

The problem described above is solved by employing a means including at least three ejector pins (83, 89) or gate bushings (65) arranged equidistantly along the peripheral direction. As a result, any unbalance along the peripheral direction can be adjusted with a higher adjusting efficiency.

According to still another aspect of the invention, there is provided a rotary blade molded by the molding method and die described above, comprising a discal rotary blade body (33) and a multiplicity of fins (35) arranged on the outer periphery of the rotary blade body (33), wherein a plurality of uneven portions (41, 43, 47) are formed in peripherally spaced relation to each other on at least one of the surfaces of the rotary blade body (33) and a means is employed to adjust the unbalance around the axis of the rotary blade by the amount of protrusion or depression of the uneven portions (41, 43, 47).

The present invention may be more fully understood from the description of preferred embodiments of the invention, as set forth below, together with the accompanying drawings.

### BRIEF DESCRIPTION OF THE DRAWINGS

FIG. 1 is a sectional view showing an injection molding die according to an embodiment of the invention.

FIG. 2A is a front view showing an impeller molded with the injection molding die shown in FIG. 1.

FIG. 2B is a view of the part indicated by arrow B-B in FIG. 2A.

FIG. 2C is a sectional view taken in line C-C in FIG. 2A.

FIG. 3 is a sectional view showing a vortex electric air pump using, for example, the impeller shown in FIG. 2A.

### DESCRIPTION OF THE PREFERRED EMBODIMENTS

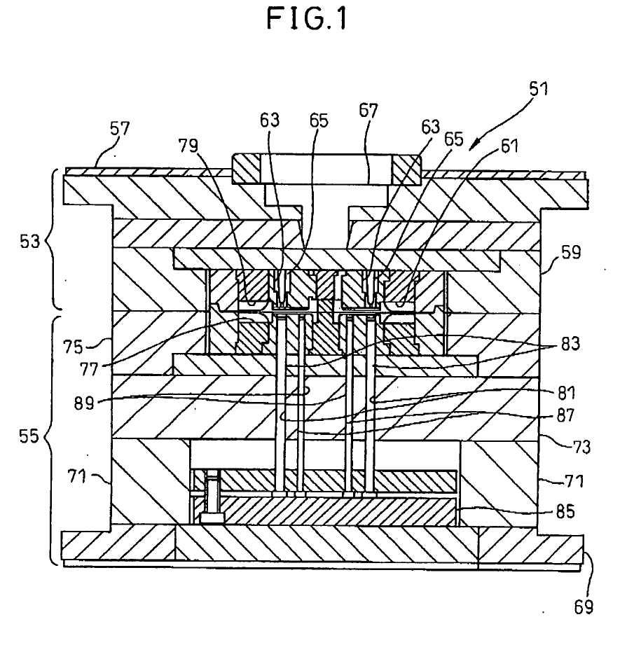

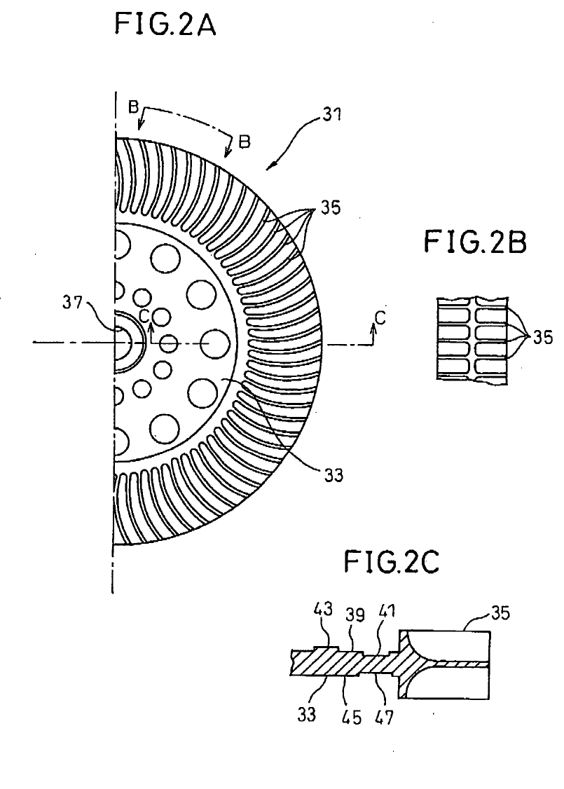

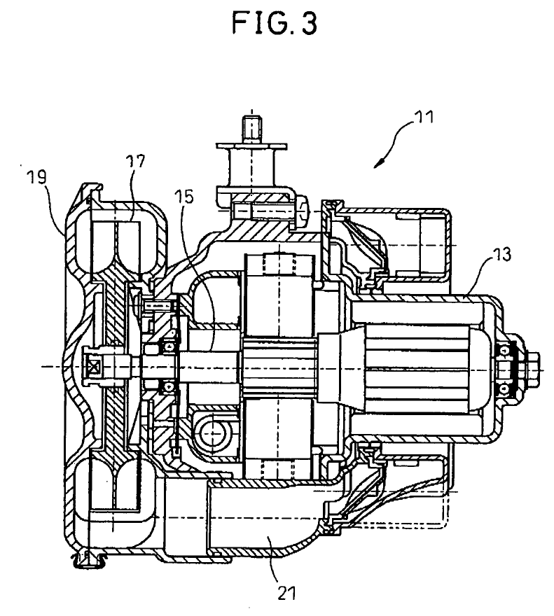

Embodiments of this invention are explained below with reference to FIGS. 1 to 2C.

FIGS. 2A to 2C show an impeller 31 molded by an injection molding method and an injection molding apparatus according to this invention. The impeller 31 includes a discal impeller body 33 and a multiplicity of fins 35 formed on the outer periphery of the impeller body 33. Also, a mounting hole 37 into which the output shaft of a motor is fixedly inserted is formed at the central portion of the impeller body 33.

On one surface 39 of the impeller body 33 of the impeller 31, 12 first circular projecting or depressed parts 41 formed by first eject pins described later are formed equidistantly along the peripheral direction. Also, 12 second circular projecting or depressed parts 43 formed by second eject pins are formed on the inside of the first uneven parts 41.

On the other surface 45 of the impeller body 33, on the other hand, 12 circular projecting or depressed parts 47 are formed by gate bushings described later.

Next, an injection molding die for molding the impeller 31 is explained with reference to FIG. 1. The injection molding die 51 includes a fixed die part 53 and a movable die part 55. The fixed die part 53 includes a fixed-side mounting plate 57 and a fixed-side die plate 59 mounted on the fixed-side mounting plate 57. The fixed-side die plate 59 is formed with a fixed-side cavity 61 for molding one axial half portion of the impeller 31. The fixed-side cavity 61 is formed with 12 through holes 63 equidistantly in peripheral direction, which are open to the cavity 61 and extending in the directions along which the fixed die part 53 and the movable die part 55 move away from and toward each other. Twelve gate bushings 65 are inserted removably into the 12 through holes 63. The molten resin is supplied to the cavity 61 through the 12 gate bushings 65. Reference numeral 67 designates a sprue bushing for supplying the molten resin to the gate bushings 65.

The movable die part 55, on the other hand, includes a movable-side mounting plate 69. A movable-side backing plate 73 is supported on the movable-side mounting plate 69 through a spacer block 71. The movable-side backing plate 73 includes a movable-side die plate 75. The movable-side die plate 75 is formed with a movable-side cavity 77 for molding the other axial half portion of the impeller 31. The movable-side cavity 77 and the fixed-side cavity 61 make up a cavity 79. The outer peripheral side of the portion of the movable-side cavity 77 defining the impeller body 33 is formed with 12 outer through holes 81 open to the cavity 79 and extending in the directions along which the fixed die part 53 and the movable die part 55 move away from and toward each other. Twelve outer ejector pins 83 are removably inserted into the 12 outer through holes 81. The bases of the outer ejector pins 83 are fixed on an ejector plate 85. Also, the inner peripheral side of the portion of the movable-side cavity 77 defining the impeller body 33 is formed with 12 inner through holes 87 open to the cavity 77 and extending in the directions along which the fixed die part 53 and the movable die part 55 move away from and toward each other. Twelve inner ejector pins 89 are removably inserted into the 12 inner through holes 87, respectively. The inner through holes 87 and the inner ejector pins 89 are smaller in diameter than the outer through holes 81 and the outer ejector pins 83, respectively. The bases of the inner ejector pins 89 are fixed on the ejector plate 85.

In this configuration, the gate bushings 65 are prepared to include a standard gate bushing 65a of such a length that the forward end surface thereof is flush with the fixed-side cavity 61 at the time of mounting, a plurality of lengthy gate bushings 65b slightly longer than the standard gate bushing 65a and having different lengths in steps (for example, 0.2 mm longer for each step) and a plurality of short gate bushings 65c slightly shorter than the standard gate bushing 65a and having different lengths in steps (for example, 0.2 mm shorter for each step). Similarly, the outer ejector pins 83 are prepared to include a standard outer ejector pin 83a of such a length that the forward end surface thereof is flush with the movable-side cavity 77 at the time of mounting, a plurality of lengthy outer ejector pins 83b slightly longer than the standard outer ejector pin 83a and having different lengths in steps (for example, 0.2 mm longer for each step) and a plurality of short outer ejector pins 83c slightly shorter than the standard outer ejector pin 83a and having different lengths in steps (for example, 0.2 mm shorter for each step). Further, the inner ejector pins 89 are prepared to include a standard inner ejector pin 89a of such a length that the forward end surface thereof is flush with the movable cavity 77 at the time of mounting, a plurality of lengthy inner ejector pins 89b slightly longer than the standard inner ejector pin 89a and having different lengths in steps (for example, 0.2 mm longer for each step) and a plurality of short inner ejector pins 89c slightly shorter than the standard inner ejector pin 89a and having different lengths in steps (for example, 0.2 mm shorter for each step).

Next, the steps of producing the impeller with the balance thereof adjusted by using the injection molding die 51 are explained.

First, the standard gate bushing 65a, the standard outer ejector pin 83a and the standard inner ejector pin 89a are mounted on the injection molding die 51. Under this condition, the molten resin is filled in the cavity 79 through the standard gate bushing 65a, after which the impeller of the molded product is released by the normal method.

The balance of the impeller molded under this standard condition is measured, and based on the result of measurement, the balance is adjusted by replacing a part of the standard gate bushing 65a, the standard outer ejector pin 83a and the standard inner ejector pin 89a already mounted with the short gate bushing 65c, the short outer ejector pin 83c, the short inner ejector pin 89c, the lengthy gate bushing 65b, the lengthy outer ejector pin 83b and the lengthy inner ejector pin 89b. Specifically, the short gate bushing 65c, the short outer ejector pin 83c and the short inner ejector pin 89c are used to increase the thickness of the part involved, while the lengthy gate bushing 65b, the lengthy outer ejector pin 83b and the lengthy inner ejector pin 89b are used to reduce the thickness of the part involved thereby to adjust the weight balance of the molded product as a whole. Once the balance is adjusted for one die, the balance of all the impellers molded by the particular die can adjusted.

As explained above, in the injection molding method for the impeller, the injection molding die for the impeller and the impeller molded thereby, the pair of the fixed-side die plate 59 and the movable-side die plate 75 adapted to move away from and toward each other are formed with the cavity 79 for molding the impeller 31 having the axis in the directions along which the fixed-side die plate 59 and the movable-side die plate 75 move away or toward from each other. At least one of the fixed-side die plate 59 and the movable-side die plate 75 is formed with a plurality of through holes 63, 81, 87 in peripherally spaced relation to each other on the inner peripheral surface of the cavity 79 and extending in the directions along which the die plates 59, 75 move away from or toward each other. The gate bushings 65, the outer ejector pins 83 and the inner ejector pins 89 are removably inserted into the plurality of the through holes 63, 81, 87 and, by changing the length of the gate bushings 65, the outer ejector pins 83 and the inner ejector pins 89 inserted into the through holes 63, 81, 87, the axial position of the forward ends thereof with respect to the inner peripheral surface of the cavity 79 is changed thereby to change the thickness of the molded product and thus adjust the balance of the impeller around the axis thereof. As a result, the subsequent thickness increase or decrease which otherwise might be required fox each molded product is not required, and as long as the balance is adjusted once for one die, the subsequent balance adjustment for the particular die is not required, thereby greatly saving the labor and cost.

Also, in the presence of the three or more outer ejector pins 83 along the peripheral direction, any unbalance in peripheral direction can be adjusted. Further, as the outer ejector pins 83 are arranged equidistantly along the peripheral direction, the unbalanced state and the countermeasures therefor can be easily analyzed.

The use of an ejector pin and a gate bushing as a columnar core, on the other hand, makes it possible to use the existing member as it is and the need of using a new column core is eliminated.

Also, as the balance can be adjusted for both sides of the impeller 51, the three-dimensional balance adjustment as well as the peripheral balance adjustment is possible.

Although the embodiments described above employ the ejector pins 83, 89 and the gate bushings 65 as columnar cores, the columnar cores are not necessarily limited to them and any cores open to the inner peripheral surface of the cavity and removably inserted into the holes extending in the directions along which the dies are moved away from or toward each other can be employed with equal effect.

The ejector pins and the nozzle inserts, which are equidistantly arranged in the peripheral direction in the embodiments described above, are not necessarily arranged equidistantly. Although the equidistant arrangement facilitates the balance adjustment, the balance adjustment is possible also with other than the equidistant arrangement.

In the embodiments described above, the short gate bushings 65c, the short outer ejector pins 83c, the short inner ejector pins 89c, the lengthy gate bushings 65b, the lengthy outer ejector pins 83b and the lengthy inner ejector pins 89b are prepared with the length thereof changed in steps of 0.2 mm. The steps, however, are not necessarily limited to the length of 0.2 mm, but can be changed in accordance with the degree of unbalance.

Also, according to the embodiments described above, the short gate bushings 65c, the short outer ejector pins 83c, the short inner ejector pins 89c, the lengthy gate bushings 65b, the lengthy outer ejector pins 83b and the lengthy inner ejector pins 89b are prepared in addition to the standard gate bushing 65a, the standard outer ejector pin 83a and the standard inner ejector pin 89a. Nevertheless, the invention is not necessarily limited to this configuration, but somewhat lengthy gate bushings, outer ejector pins and inner ejector pins may be prepared and appropriately machined in grinder, etc. for balance adjustment.

In the embodiments described above, the injection molding method and the injection molding die are taken as an example of the molding method and the molding apparatus, respectively. Nevertheless, the invention is of course applicable also to die cast molding and a cast molding process with equal effect.

While the invention has been described by reference to specific embodiments chosen for purposes of illustration, it should be apparent that numerous modifications could be made thereto, by those skilled in the art, without departing from the basic concept and scope of the invention.

1. A method of molding a rotary blade:
wherein a cavity (79) for molding a rotary blade (31) having an axis in the direction along which a pair of dies (59, 75) are moved away from and toward each other is formed between the dies (59, 75);
wherein a plurality of holes (63, 81, 87) opening to the inner peripheral surface of the cavity (79) in peripherally spaced relation with each other and extending in the direction along which the dies (59, 75) are moved away from or toward each other are formed on at least one of the dies (59, 75);
wherein ejector pins (83, 89) are removably inserted in the plurality of the holes (63, 81, 87), respectively; and
wherein the thickness of a molded product is changed by changing the length of the ejector pins (83, 89) inserted into the holes and thus changing the axial position of the forward end surfaces of the ejector pins (83, 89) with respect to the inner peripheral surface of the cavity (79) thereby to adjust the balance of the rotary blade (31) around the axis thereof.

2. The molding method according to claim 1,
wherein at least three ejector pins (83, 89) are arranged equidistantly along the peripheral direction.

3. A rotary blade molded by the rotary blade molding method as set forth in claim 1.

4. A method of molding a rotary blade:
wherein a cavity, (79) for molding a rotary blade (31) having an axis in the direction along which a pair of dies (59, 75) are moved away from and toward each other is formed between the dies (59, 75);
wherein a plurality of holes (63, 81, 87) opening to the inner peripheral surface of the cavity (79) in peripherally spaced relation with each other and extending in the direction along which the dies (59, 75) are moved away from or toward each other are formed on at least one of the dies (59, 75);
wherein gate bushings (65) are removably inserted in the plurality of the holes (63, 81, 87), respectively; and
wherein the thickness of a molded product is changed by changing the length of the gate bushings (65) inserted into the holes and thus changing the axial position of the forward end surfaces of the gate bushings (65) with respect to the inner peripheral surface of the cavity (79) thereby to adjust the balance of the rotary blade around the axis thereof.

5. The molding method according to claim 4,
wherein at least three gate bushings (65) are arranged equidistantly along the peripheral direction.

6. A rotary blade molded by the rotary blade molding method as set forth in claim 4.

7. A rotary blade molding die having a cavity (79) formed between the dies (59, 75), for molding a rotary blade (31) having an axis in the direction along which a pair of dies (59, 75) are moved away from and toward each other;
wherein a plurality of holes (63, 81, 87) opening in the peripheral direction-of the cavity (79) in spaced relation with each other and extending in the direction along which the dies (59, 75) are moved away from or toward each other are formed on at least one of the dies (59, 75);
wherein ejector pins (83, 89) are removably inserted in the plurality of the holes (63, 81, 87), respectively; and
wherein the thickness of a molded product is changed by changing the length of the ejector pins (83, 89) inserted into the holes (63, 81, 87) and thus changing the axial position of the forward end surfaces of the ejector pins (83, 89) with respect to the inner peripheral surface of the cavity (79) thereby to adjust the balance of the resulting rotary blade (31) around the axis thereof.

8. The molding die according to claim 7,
wherein at least three ejector pins (83, 89) are arranged equidistantly in the peripheral direction.

9. A rotary blade molded by the rotary blade molding die as set forth in claim 7.

10. A rotary blade molding die having a cavity (79) formed between the dies (59, 75), for molding a rotary blade (31) having an axis in the direction along which a pair of dies (59, 75) are moved away from or toward each other;
wherein a plurality of holes (63, 81, 87) opening in the peripheral direction of the cavity (79) in spaced relation with each other and extending in the direction along which the dies (59, 75) are moved away from or toward each other are formed on at least one of the dies (59, 75);
wherein gate bushings (65) are removably inserted in the plurality of the holes (63, 81, 87), respectively; and
wherein the thickness of a molded product is changed by changing the length of the gate bushings (65) inserted into the holes (63, 81, 87) and thus changing the axial position of the forward end surfaces of the gate bushings (65) with respect to the inner peripheral surface of the cavity (79) thereby to adjust the balance of the resulting rotary blade (31) around the axis thereof.

11. The molding die according to claim 10,
wherein at least three gate bushings (65) are arranged equidistantly along the peripheral direction.

12. A rotary blade molded by the rotary blade molding die as set forth in claim 10.
